(19) United States
(12) Patent Application Publication
(10) Pub. No.: US 2023/0052860 A1
(43) Pub. Date: Feb. 16, 2023

(54) SYSTEMS AND METHODS FOR SMART CONTRACTS USING MULTIPLE DISTRIBUTED LEDGERS

(71) Applicant: JPMORGAN CHASE BANK , N.A., New York, NY (US)

(72) Inventors: Prashant BAJ, Pune (IN); Prince Kumar MAURYA, Stony Brook, NY (US); Ambika TAPLOO, Rohini (IN); Richa PANDEY, Mumbai (IN); Jinal SHAH, Mumbai (IN)

(21) Appl. No.: 17/651,003

(22) Filed: Feb. 14, 2022

(30) Foreign Application Priority Data
Aug. 10, 2021 (IN) 202111036056

(51) Int. Cl. G06Q 20/38; G06Q 20/06; G06Q 40/08

(52) U.S. Cl. CPC G06Q 20/3825; G06Q 20/3827; G06Q 20/389; G06Q 20/065; G06Q 40/08

(57) ABSTRACT

Systems and methods for complex process flow approval using distributed ledgers are disclosed. The method may include generating a process initiation message based on input from a second service provider or a user. The method may include recording the process initiation message on a first distributed ledger. The method may include monitoring the first distributed ledger for an indication of an approval event. The method may include generating a settlement event based on the indication of the approval event. The method may include recording the settlement event on the first distributed ledger. The method may include communicating a settlement event message to a second distributed ledger. The method may include generating a virtual payment instrument associated with the settlement event message, the indication of the approval event, and the process initiation message.

### RELATED APPLICATIONS

This application claims priority to Indian Patent Application No. 202111036056, filed Aug. 10, 2021, the disclosure of which is hereby incorporated, by reference, in its entirety.

### BACKGROUND OF THE INVENTION

### 1. Field of the Invention

Embodiments are generally related to systems and methods for multiple ledger smart contracts.

### 2. Description of the Related Art

Processing complex approval processes between disparate entities involves the coordination of multiple parties and systems. For example, various process flow approvals, legal regulations, differing processing times, and delays for authentication requirements and fraud prevention. The sheer number of parties often causes processing delays and increases the timeframe for payment processing resolution.

### SUMMARY OF THE INVENTION

Systems and methods for complex process flow approval using distributed ledgers are disclosed. According to one embodiment, a method for complex process flow approval may include generating, by a first service provider, a process initiation message based on input from a second service provider or a user. The method may further include recording, on a first distributed ledger, the process initiation message. The method may further include monitoring, by a smart contract, the first distributed ledger for an indication of an approval event associated with the process initiation message. The method may further include generating, by the first service provider, a settlement event based on the indication of the approval event. The method may further include recording, on the first distributed ledger, the settlement event. The method may further include communicating a settlement event message to a second distributed ledger. The method may further include generating, based on the settlement event message, a virtual payment instrument or instrument associated with the settlement event message, the indication of the approval event, and the process initiation message.

In some embodiments, the settlement event message comprises a process or workflow case (e.g., an insurance claim) identifier, a recipient, a value associated with the recipient, and a status indicator of the settlement event.

In some embodiments, the process initiation message comprises a beneficiary name, a beneficiary identification number, a counterparty account identifier, amount, a process identifier, a process status, and a creation date.

In some embodiments, generating the virtual payment instrument includes receiving, by a financial institution, the settlement event message. The financial institution may generate a virtual payment instrument based on the settlement event message. The financial institution may record, on the second distributed ledger, an identifier of the virtual payment instrument. The financial institution may assign a value to the virtual payment instrument/instrument based on the approval event.

In some embodiments, the method may include funding the virtual payment instrument based on the value assigned. The method may further include settling a transaction, using the virtual payment instrument, with one or more recipients based on the approval event, the settlement event.

In some embodiments, the method may include monitoring, the first distributed ledger for an indication of an business process and approval events. In some embodiments, the method may include polling the first distributed ledger by the smart contract. In some embodiments, the method may include detecting an entry written to the first distributed ledger that includes one or more approvals and a complete status identifier.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts an example of a system for complex process flow approval using distributed ledgers, according to certain embodiments of the present disclosure.

FIG. 2 depicts an example of a system for a healthcare process flow approval using distributed ledgers, according to certain embodiments of the present disclosure.

FIG. 3 depicts an example of a complex process flow approval using distributed ledgers, according to certain embodiments of the present disclosure.

FIG. 4 depicts an example of computing device 400 according to certain embodiments of the present disclosure.

### DETAILED DESCRIPTION OF PREFERRED EMBODIMENTS

Embodiments are directed to systems and methods for complex process flow approval using distributed ledgers. For example, embodiments may leverage the use of distributed ledgers, smart contracts, and supporting technologies to initiate and complete complex process flows. Embodiments may address issues in processing a complex process flow and related settlement processing.

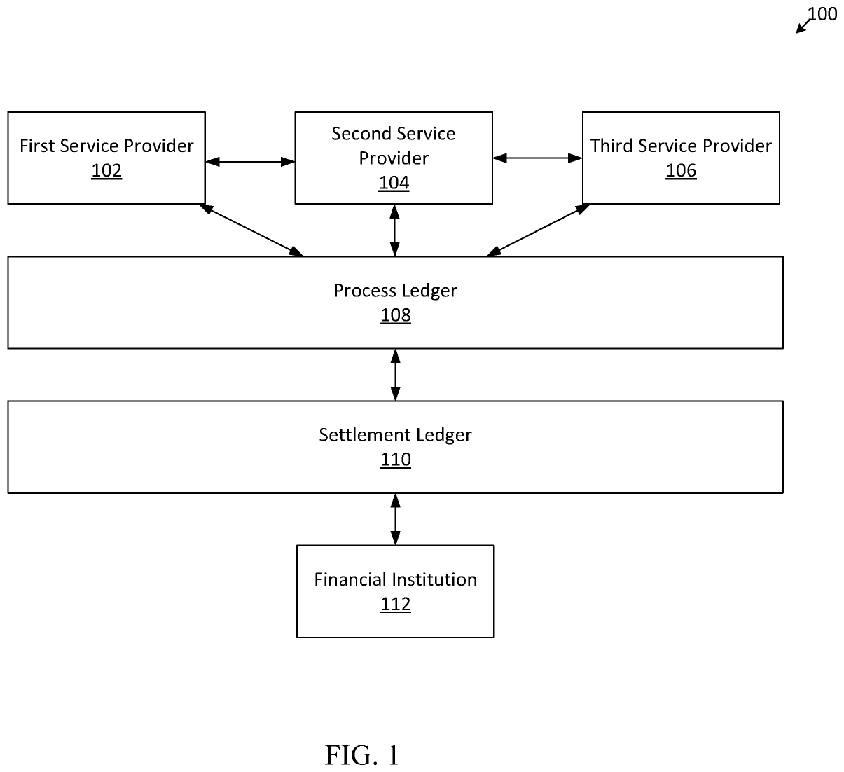

Referring now to the figures, FIG. 1 depicts a system for management of complex process approval flows using multiple distributed ledgers is disclosed according to certain embodiments of the present disclosure. System 100 may include first service provider 102, second service provider 104, third service provider 106, a process ledger 108, a settlement ledger 110, and a financial institution 112. As one of skill in the art will appreciate, while FIG. 1 depicts three service providers, any number of service providers can be implemented without departing from the teachings of the present disclosure.

First service provider 102 may be an entity that interfaces with a user, such as by a mobile application executed on a mobile device. The first service provider 102 may provide the user with a service based on an agreement between the user and the first service provider 102. The first service provider 102 may initiate an approval process on behalf of or at the request of the user based on the interaction of the first service provider 102 and the user. The first service provider 102 may communicate an initiation message to other components of system 100 including the process ledger 108.

The second service provider 104 may be a different entity that interfaces with a user, such as by a mobile application executed on a mobile device (e.g., telemedicine application) or that in a physical interaction to provide medical care. The second service provider 104 may provide the user with a service based on an agreement between the user and the second service provider 104. The second service provider 104 may generate an invoice or settlement request on behalf of user based on the interaction of the second service provider 104 and the user. The second service provider 104 may determine a value of the invoice or settlement based on a pre-determined or dynamic agreement according to the medical care provided. In one example, the second service provider 104 may generate an initiation message to the first service provider 102 including the amount of the invoice or the settlement.

The third service provider 106 may be a different entity that provides access to a medical facility for a user during a physical interaction with the second service provider 104. The third service provider 106 may provide the user with access to a particular physical or electronic facility based on an agreement between the user and the third service provider 106 or an agreement between the second service provider 104 and the third service provider 106. The third service provider 106 may generate an invoice or settlement request on behalf of user based on the facility accessed by the user. The third service provider 106 may determine a value of the invoice or settlement based on a pre-determined or dynamic agreement according to the medical facility accessed. In one example, the third service provider 106 may generate an initiation message to the first service provider 102 including the amount of the invoice or the settlement.

The process ledger 108 may be a distributed ledger such as Ethereum, Hyperledger Fabric, R3 Corda, or Quorum. The process ledger 108 may record transactions of a complex process flow from the first service provider 102, second service provider 104, or third service provider 106. The process ledger 108 may be used to store information relating to the services provided by the first service provider 102, second service provider 104, or third service provider 106. In one example, financial institution 112 may provision access to the process ledger 108.

The settlement ledger 110 may be a distributed ledger such as Ethereum, Hyperledger Fabric, R3 Corda, or Quorum. The settlement ledger 110 may record transactions of a complex process flow from the first service provider 102, second service provider 104, or third service provider 106, and the financial institution 112. The settlement ledger 110 may be used to store information relating to the patient and transaction data associated with the complex process flow. In one example, financial institution 112 may provision access to the process ledger 108. The financial institution may encrypt or deny access to particular blocks or information written to the second distributed ledger (e.g., personal identifiable information, patient medical care data, etc.).

In some embodiments, the financial institution 112 may send and receive communications from the first service provider 102, second service provider 104, third service provider 106, process ledger 108, or settlement ledger 110. The financial institution 112 may include one or more integrated smart contracts to provide an immutable chain of process status, approval events, settlement events, and the like.

While FIG. 1 is described with service providers that communicate, it should be understood that the system of FIG. 1 may be configured to have independent service providers such as a process management ledger with isolated service providers such that each may have independent processes such as an aviation process, a logistics process, a hospitality process, and the like.

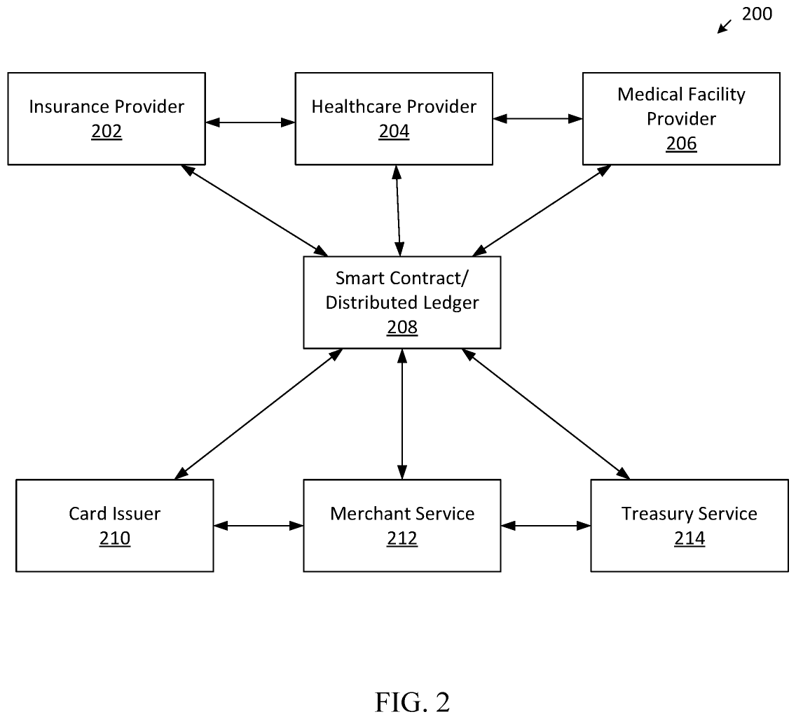

FIG. 2 depicts a system for management of a healthcare claim approval process using multiple distributed ledgers is disclosed according to certain embodiments of the present disclosure. System 200 may include insurance provider 202, healthcare provider 204, medical facility provider 206, a smart contract 208, a card issuer 210, a merchant service 212, and a treasury service 214.

The insurance provider 202 may be a company or application that interfaces with a user to provide insurance services. Examples of insurance services includes providing the user an interface, such as by a mobile application executed on a mobile device to send and receive information from the insurance provider 202. The user may use the mobile application to initiate an insurance claim filing, receive notifications of status for the claim approval process, or respond to requests for information submitted to the insurance provider from other components of system 200.

The healthcare provider 204 may be a company or application that interfaces with a user to provide healthcare services to the user. Examples of healthcare services includes providing the user with in-person medical treatment, telehealth treatment, or other medical procedures. In some cases, the healthcare services provided by healthcare provider 204 may be provided within a medical facility, such as a hospital, doctor's office, or the like. The healthcare provider 204 may provide the healthcare services to the user upon authentication of an insurance account, receipt of a deposit amount or deductible payment, or some other requirements imposed on the user by the healthcare provider 204.

The medical facility provider 206 may be a company that provides the user access to a medical facility for receipt of healthcare services from healthcare provider 204. Examples of medical facilities include hospitals, out-patient treatment centers, healthcare provider's office, or the like. The medical facility provider may provide medical facility access to the user upon authentication of an insurance account, receipt of a deposit amount or deductible payment, or some other requirements imposed on the user by the medical facility provider 206.

The smart contract 208 may generate a self-executing approval process including insurance provider 202, healthcare provider 204, medical facility provider 206, card issuer 210, merchant service 212, and treasury service 214. The smart contract 208 provides trusted transactions to be carried out among the various entities of system 200 while reducing the processing times and approval process errors that exist in traditional approaches. The smart contract 208 may record approval process data on two separate distributed ledgers. The smart contract 208 may store service provider information on a process ledger while storing financial transaction information on a settlement ledger. The smart contract 208 may control access to the process ledger and the settlement ledger based on an access control policy determined by the financial institution providing the card issuer 210, the merchant service 212, or the treasury service 214. While FIG. 2 depicts one smart contract, multiple smart contracts that are nested, or otherwise related in a complex approval process are possible. In one example implementing multiple smart contracts, each smart contract may read or record from multiple distributed ledgers and further provide an output to another smart contract or receive an output from another smart contract.

The card issuer 210 may provide one or more payment instruments for funding a transaction relating to the approval process. The payment instrument may include credit cards, debit cards, rewards points, loyalty points, etc. as well as access points to non-payment accounts for payment (e.g., lines of credit, such as a HELOC, mortgages, etc.), applications for secured and unsecured credit, etc. In one aspect, the card issuer may generate a virtual account based on information received during the approval process. The card issuer 210 may provide payment instrument information to the smart contract 208.

The merchant service 212 may perform various functions to settle any financial transactions associated with a particular approval process. For instance, the merchant service 212 may authorize payment instruments, receive and process settlement of financial transactions, determining settlement values, or sending funding instructions to the smart contract 208.

The treasury service 214 may receive funding information from the merchant services via the smart contract 208 and process a funds transfer from the payment instrument issued by card issuer 210 to one or more accounts of the insurance provider 202, healthcare provider 204, medical facility provider 206, or a financial account associated with the user.

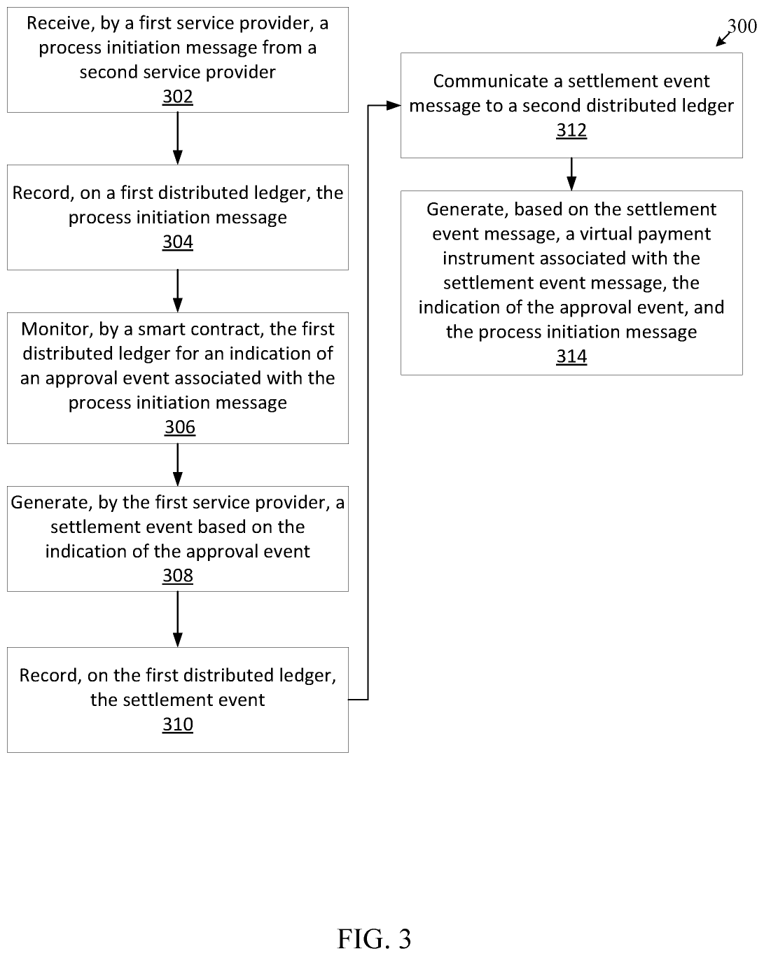

FIG. 3 depicts an example of a process for management of complex process approval flows using multiple distributed ledgers is disclosed according to certain embodiments of the present disclosure.

At step 302, the process 300 involves generating, by a first service provider, a process initiation message based on input from a second service provider or a user. In an example, the first service provider may be an application that receives a claim filing submission from a user or from a healthcare provider that initiates a claim for medical services on behalf of the user. The first service provider may generate a process initiation message that includes metadata received from the user or the second service provider as well as metadata generated by the first service provider. For instance, the process initiation message may include details associated with the patient such as patient name, patient identification number, insurance account identifier, and claim amount. The process initiation message may further include a claim identifier, a claim status, and a creation date.

At step 304, the process 300 involves recording, on a first distributed ledger, the process initiation message. Continuing with the previous example, the first service provider may communicate the process initiation message to the smart contract. The smart contract may record the process initiation message on the process ledger. The smart contract may assign an approval process to one or more approving entities as described with regard to FIGS. 1-2. The smart contract may make available to the one or more approving entities, one or more blocks of the first distributed ledger that are associated with the process initiation message. In some embodiments, the first distributed ledger may be customizable based on a particular industry associated with the approval process, particular combination of approving entities, or a number of steps in the approval process. For instance, the first distributed ledger may be also called a process distributed ledger that is unique to the particular approval process associated with the first distributed ledger. In other embodiments, multiple instances of the first distributed ledger can provide multiple parallel approval processes.

At step 306, the process 300 involves monitoring, by a smart contract, the first distributed ledger for an indication of an approval event associated with the process initiation message. The smart contract may notify the one or more approving entities of an approval task. After each of the one or more approving entities has completed the assigned approval task, the smart contract may update the status of the approval process on the first distributed ledger. Upon completion of all assigned tasks, the smart contract may determine that the approval process is complete. For instance, the smart contract may poll the entries that are written to the first distributed ledger or detect that a new entry is being written to the first distributed ledger.

At step 308, the process 300 involves generating, by the first service provider, a settlement event based on the indication of the approval event. As described with regard to step 306, the smart contract may determine that the approval process is completed by detecting that all assigned tasks as completed. The smart contract may notify the first service provider that the approval process is completed and a settlement event may be generated. The first service provider may generate a settlement event that includes the claim identifier, recipient, value associated with the recipient, and a status indicator. In one example, the smart contract may detect that all assigned tasks are completed by detecting that the number of pending assigned tasks is zero.

At step 310, the process 300 involves recording, on the first distributed ledger, the settlement event. The first service provider may record the settlement associated with the approval event to the first distributed ledger and include settlement details as described above.

At step 312, the process 300 involves communicating a settlement event message to a second distributed ledger. In one example, the smart contract may record the settlement event on the second distributed ledger and make the settlement event available to a card issuer, a merchant service, or a treasury service. The smart contract may copy the settlement event from the first distributed ledger to the second distributed ledger. In other examples, the smart contract may generate a settlement event that includes a portion of the settlement event from the first distributed ledger and additional settlement parameters such as financial institution, insurance account, settlement values, and the like. In some embodiments, the second distributed ledger may be shared by multiple industries associated with various approval processes, multiple types of approving entities, or the like. For instance, the second distributed ledger may be shared between multiple instances of smart contracts with a first distributed ledger. In these embodiments, the second distributed ledger may be called a settlement ledger for multiple process ledgers.

At step 314, the process 300 involves generating, based on the settlement event message, a virtual payment instrument associated with the settlement event message, the indication of the approval event, and the process initiation message. The card issuer may provision a virtual payment instrument associated with a value of the settlement. The merchant service may authorize a transaction having a value that is associated with the settlement. The treasury service may provide a funding event to one or more recipient accounts associated with the insurance provider, the healthcare provider, or the medical facility provider.

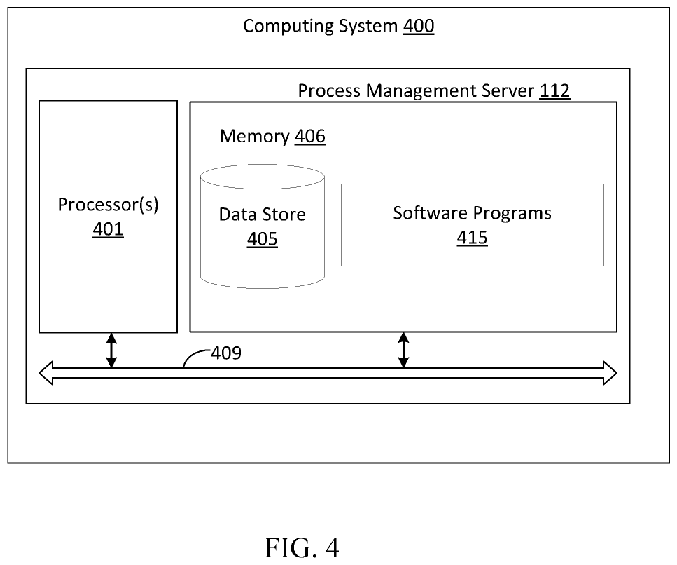

FIG. 4 depicts an example of computing device 400 according to certain embodiments of the present disclosure. The implementation of computing device 400 could be used for one or more of financial institution 112. The depicted example of the computing device 400 includes a processor 403 coupled to a memory 406. The processor 403 executes computer-executable program code stored in memory 406, such as software programs 415 and stores program-related information in data store 403. The processor 403 and the memory 406 may be coupled by a bus 409. In some examples, the bus 409 may also be coupled to one or more network interface devices (not shown).

Although several embodiments have been disclosed, it should be recognized that these embodiments are not exclusive to each other, and certain elements or features from one embodiment may be used with another.

Hereinafter, general embodiments of implementation of the systems and methods of the invention will be described.

The system of the invention or portions of the system of the invention may be in the form of a “processing machine,” such as a general-purpose or specialized computing device, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or a software application.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for complex process flow approval using distributed ledgers, the method comprising:
generating, by a first service provider of a plurality of service providers, a process initiation message based on input from a second service provider or a user;
recording, on a first distributed ledger, the process initiation message;
monitoring, by a smart contract, the first distributed ledger for an indication of an approval event associated with the process initiation message, wherein the monitoring comprises:
assigning a task to one or more service providers of the plurality of service providers; and
determining one or more task completions associated with the task, the one or more service providers, and the process initiation message;
generating, by the first service provider, a settlement event based on the indication of the approval event;
recording, on the first distributed ledger, the settlement event;
communicating a settlement event message to a second distributed ledger; and
generating, based on the settlement event message, a virtual payment instrument associated with the settlement event message, the indication of the approval event, and the process initiation message.

2. The method of claim 1, wherein the settlement event message comprises a claim identifier, a recipient, a value associated with the recipient, and a status indicator of the settlement event.

3. The method of claim 1, wherein process initiation message comprises a party name, a party identification number, an account identifier, a disbursement amount, a process identifier, a process status, and a creation date.

4. The method of claim 1, wherein generating the virtual payment instrument comprises:
receiving, by a financial institution, the settlement event message;
generating a virtual payment instrument based on the settlement event message;
recording, on the second distributed ledger, an identifier of the virtual payment instrument; and
assigning a value to the virtual payment instrument based on the approval event.

5. The method of claim 4 further comprising:
funding the virtual payment instrument based on the value assigned; and
settling a transaction, using the virtual payment instrument, with one or more recipients based on the approval event, the settlement event.

6. The method of claim 1, wherein monitoring, the first distributed ledger for an indication of an approval event comprises:
polling the first distributed ledger by the smart contract; and
detecting an entry written to the first distributed ledger that includes one or more approvals and a complete status identifier.

7. A system for complex process flow approval using distributed ledgers, the system comprising:
a memory; and
a processor, wherein the processor is configured to perform instructions stored in memory that cause the processor to perform operations comprising:
receiving, from a first service provider of a plurality of service providers, a process initiation message based on input from a second service provider of the plurality of service providers;
recording, on a first distributed ledger, the process initiation message;
monitoring, by a smart contract, the first distributed ledger for an indication of an approval event associated with the process initiation message, wherein the monitoring comprises:
assigning a task to one or more service providers of the plurality of service providers; and
determining one or more task completions associated with the task, the one or more service providers, and the process initiation message;
generating, by the first service provider, a settlement event based on the indication of the approval event;
recording, on the first distributed ledger, the settlement event;
communicating, to a server device, a settlement event message to a second distributed ledger; and
generating, by the server device and based on the settlement event message, a virtual payment instrument associated with the settlement event message, the indication of the approval event, and the process initiation message.

8. The system of claim 7, wherein the settlement event message comprises a process identifier, a recipient, a value associated with the recipient, and a status indicator of the settlement event.

9. The system of claim 7, wherein process initiation message comprises a party name, a party identification number, an account identifier, a process amount, a process identifier, a process status, and a creation date.

10. The system of claim 7, wherein the operation of generating the virtual payment instrument comprises:
receiving, by the server device, the settlement event message;
generating a virtual payment instrument based on the settlement event message;
recording, on the second distributed ledger, an identifier of the virtual payment instrument; and
assigning a value to the virtual payment instrument based on the approval event.

11. The system of claim 10, wherein the operation of generating the virtual payment instrument comprises:
funding, by the server device, the virtual payment instrument based on the value assigned; and
settling a transaction, using the virtual payment instrument, with one or more recipients based on the approval event, the settlement event.

12. The system of claim 7, wherein the operation of monitoring the first distributed ledger for an indication of an approval event comprises:
polling the first distributed ledger by the smart contract; and
detecting an entry written to the first distributed ledger that includes one or more approvals and a complete status identifier.

13. A method for complex process flow approval using distributed ledgers, the method comprising:
generating, by a first service provider of a plurality of service providers, a process initiation message based on an interaction between a user and a second service provider of the plurality of service providers;
recording the process initiation message on a first distributed ledger;
determining, by a smart contract, one or more tasks associated with the process initiation message;
generate a list of assigned tasks, wherein each assigned task is associated with a selected service provider of the plurality of service providers and the process initiation message;
assigning a first task of the list of assigned tasks to the selected service
provider of a plurality of service providers;
generating, by the first service provider, a settlement event based on an indication of an approval event, wherein the indication of the approval event comprises a completion status of the list of assigned tasks;
recording, on the first distributed ledger, the settlement event;
communicating a settlement event message to a second distributed ledger; and
generating, based on the settlement event message, a virtual payment instrument associated with the settlement event message, the indication of the approval event, and the process initiation message.

14. The method of claim 13, wherein the settlement event message comprises a claim identifier, a recipient, a value associated with the recipient, and a status indicator of the settlement event.

15. The method of claim 13, wherein process initiation message comprises a patient name, a patient identification number, an insurance account identifier, a claim amount, a claim identifier, a claim status, and a creation date.

16. The method of claim 13, wherein generating the virtual payment instrument comprises:
receiving, by a financial institution, the settlement event message;
generating a virtual payment instrument based on the settlement event message;
recording, on the second distributed ledger, an identifier of the virtual payment instrument; and
assigning a value to the virtual payment instrument based on the approval event.

17. The method of claim 16 further comprising:
funding the virtual payment instrument based on the value assigned; and
settling a transaction, using the virtual payment device, with one or more recipients based on the approval event, the settlement event.

18. The method of claim 13, wherein monitoring, the first distributed ledger for an indication of an approval event comprises:
polling the first distributed ledger by the smart contract; and detecting an entry written to the first distributed ledger that includes one or more approvals and a complete status identifier.
